(19) United States
(12) Patent Application Publication
(10) Pub. No.: US 2010/0182397 A1
(43) Pub. Date: Jul. 22, 2010

(54) Connector panel for view camera capable of docking digital single lens reflex camera

(76) Inventors: Eun Jeong Choi, Bundang-gu (KR); Jong Ok Lee, Bundang-gu (KR)

Correspondence Address: Eun Jeong Choi, 205-603 Daewoo Apt. Top Village, Yatap-dong 535, Bundang-gu, Gyeonggi-do, 463-840, KR

(21) Appl. No.: 12/460,622

(22) Filed: Jul. 22, 2009

(30) Foreign Application Priority Data
Jan. 16, 2009 (KR) 2009-0003956
Jun. 30, 2009 (KR) 2009-0059262

(51) Int. Cl. H04N 5/225

(52) U.S. Cl. 348/36; 348/375; 348/E05.024

(57) ABSTRACT

As a back panel of a view camera, the connector panel (100) attaches a digital single lens reflex camera to a view camera. The connector panel comprises a base panel (110), sliding panel (140), protruding pieces (130), and a mount ring (160). Two guiding strips (150) are attached to the base panel, allowing the sliding panel to be shifted side-to-side. This horizontal movement produces panorama photographs with no distortions and financial burden. Moreover, photographs can be taken at various angles as the mount ring, where the DSLR camera is attached, can rotate both clockwise and counter-clockwise. Lastly, the connector panel allows view camera's images to be saved as digital images through DSLR camera's imaging sensor, such as CCD and CMOS. Hence, view camera's images become easier to be saved, edited, and developed.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field

This application relates to large format cameras, particularly to a view camera.

2. Prior Art

Generally cameras are classified as small, medium, and large format cameras. Among the three, large format cameras refer to cameras that use 4×5 inches sized large sheet films. Images of large format cameras are viewed through a ground glass; hence they are also called view cameras.

A view camera comprises a front standard where a lens is attached, a rear standard where a photographic film holder is placed, and a flexible bellows which forms a light-tight seal between the front standard and the back standard, allowing various movements for the camera. Through these movements; such as rise, fall, shift, tilt, and swing; various framing, perspectives, and focal planes can be created.

View cameras provide not only variety but also accuracy in expressing a certain subject. In addition to movements, a view camera produces photographs with no parallex and maintains 100 visual field ratio. Also, with a view camera, one focuses by looking directly at a big film-like focal glass; thus one can perform very accurate focusing and framing by using a magnifier, such as Lupe. Hence, large format cameras are essential for professional photographers who photograph advertisement photos, architectural photos, landscape photos, etc.

Despite the advantages stated above, view cameras became obsolete due to a number of disadvantages:
(a) Films used for view cameras are expensive.
(b) Developing those films is expensive.
(c) Polaroid films, which are used to predict the results, are expensive.
(d) One needs to purchase a light meter in order to measure the exposed light.
As digital single lens reflex cameras are being generalized to the public, films are no longer needed and people are now used to reviewing images on the LCD screen instantly after the pictures are taken. Therefore, people no longer use film cameras, especially view cameras. Despite its many advantages, a view camera is usually used as a prop for interior design or just stacked away.

Hereupon, some view camera manufacturers and digital pack producers have created electronic image sensors to be attached on the back of a view camera to store images as digital images. However, this digital camera back is extremely expensive hence the number of users is very small.

### SUMMARY

A connector panel comprises a base panel, a sliding panel, protruding pieces, and a mount ring.

### DRAWINGS

### Figures

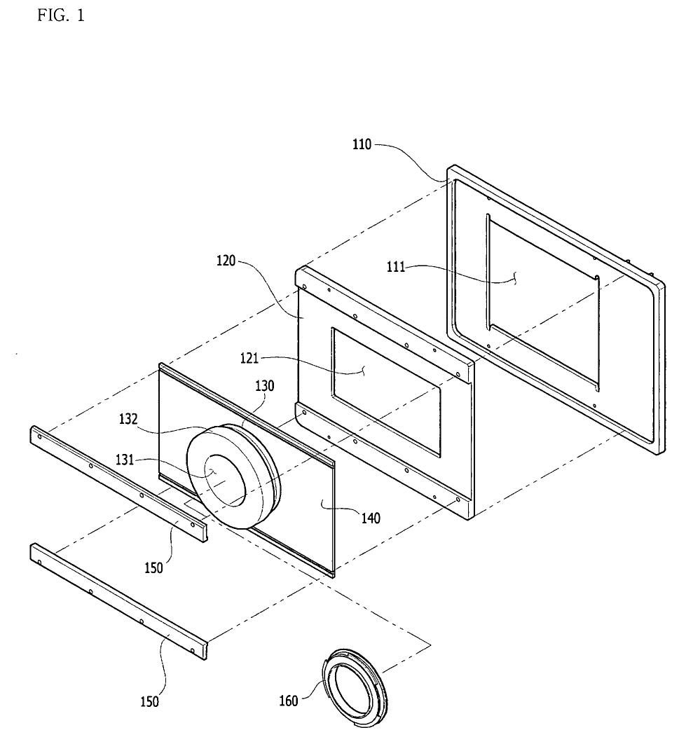

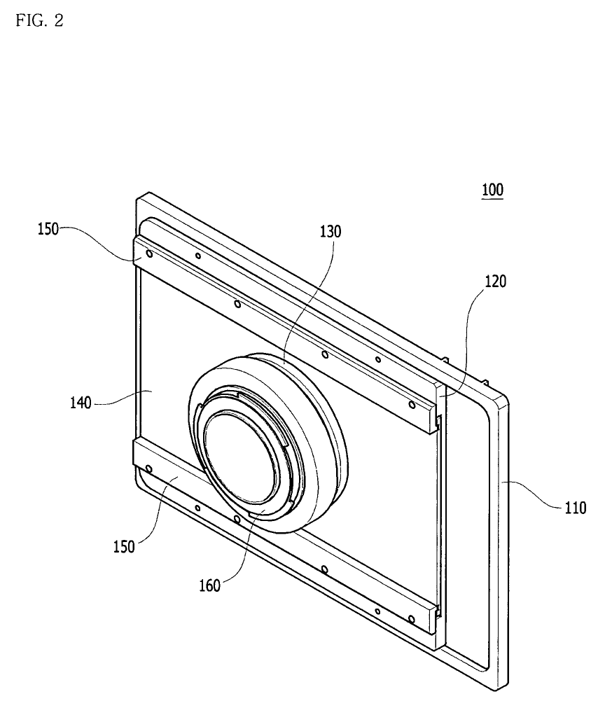

FIG. 1 shows an exploded view of a connector panel.

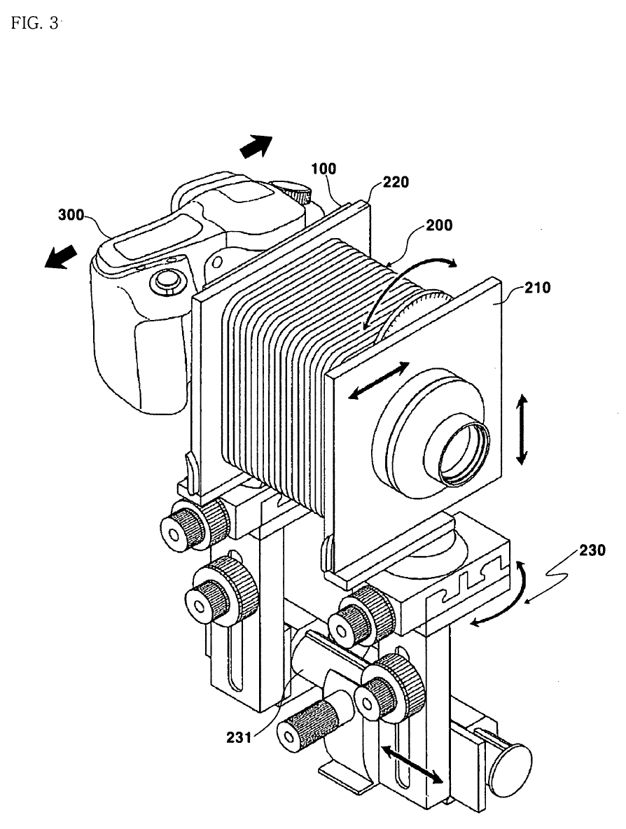

FIG. 2 shows a front view of a connector panel.

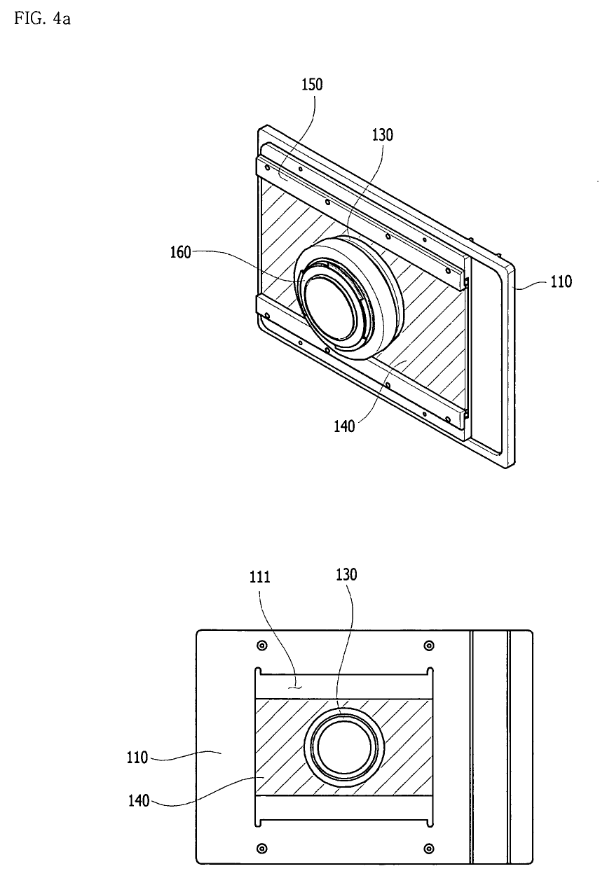

FIG. 3 shows a perspective view of a complete assembly of a DSLR camera, a connector panel, and a view camera.

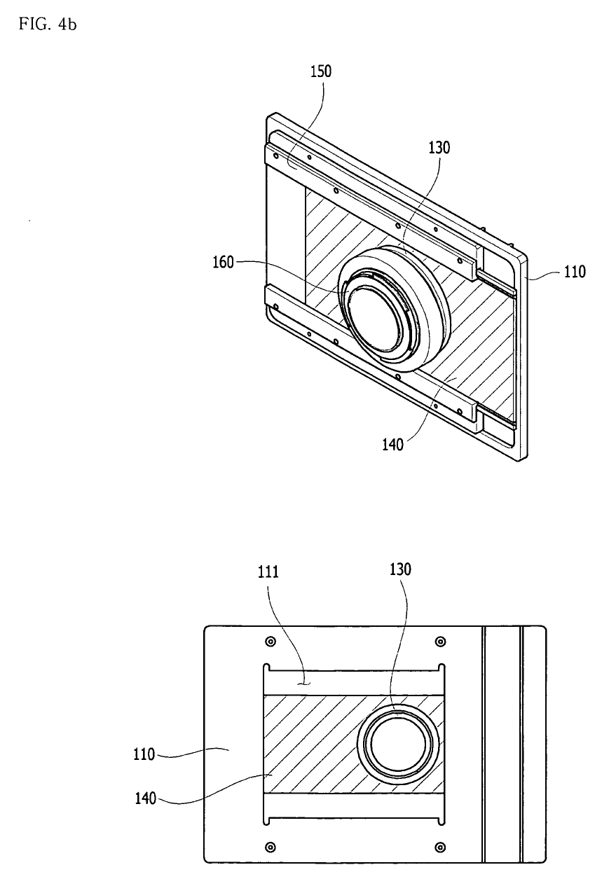

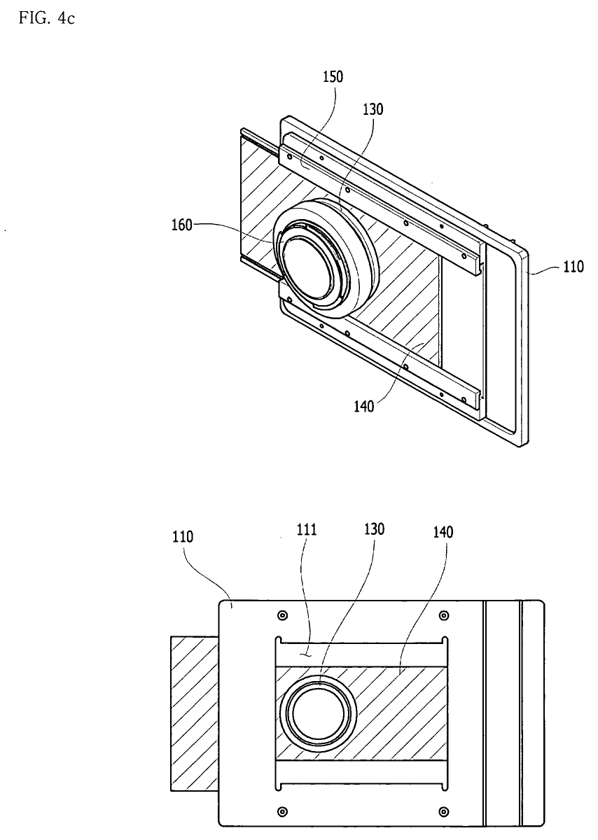

FIGS. 4a to 4c show a front view and a rear view of a connector panel when a sliding panel is shifted horizontally.

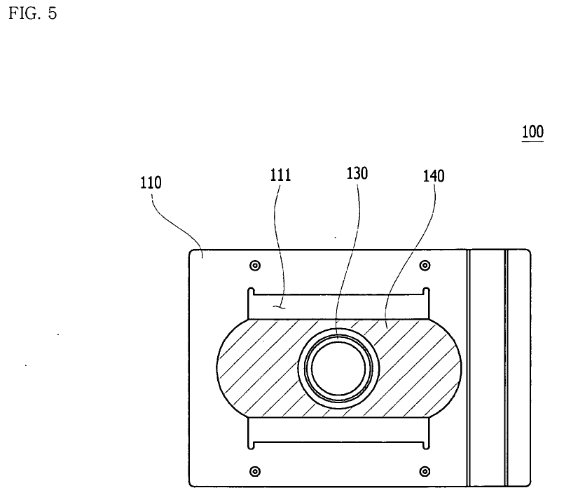

FIG. 5 shows a rear view of a connector panel.

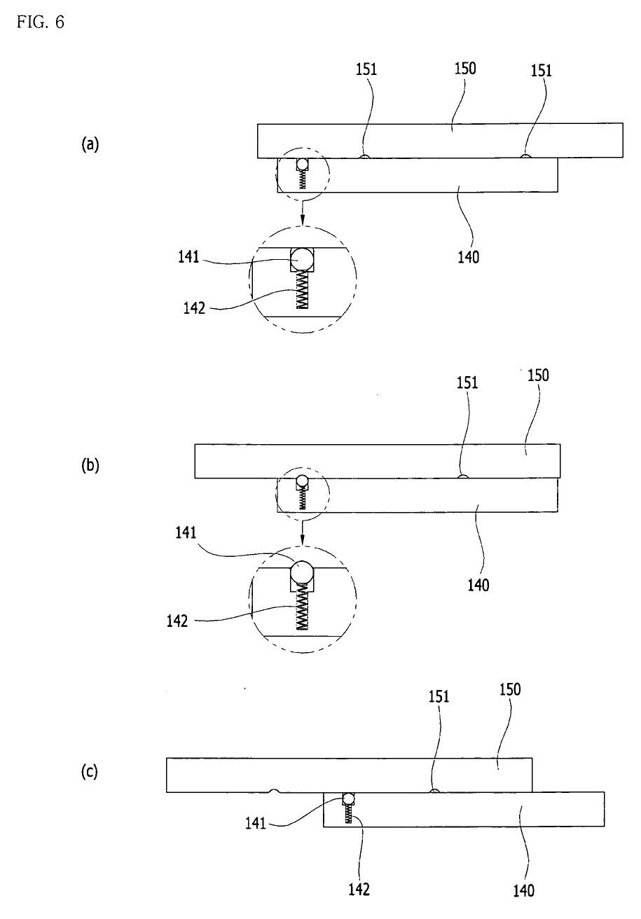

FIG. 6 shows the principle behind designated pauses during horizontal shifting of a sliding panel.

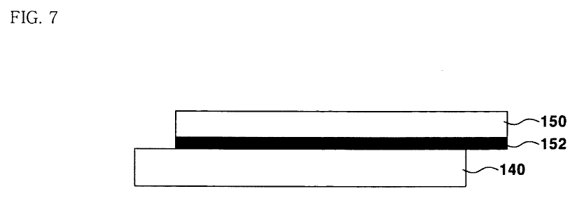

FIG. 7 shows a sliding pad attached to a guiding strip.

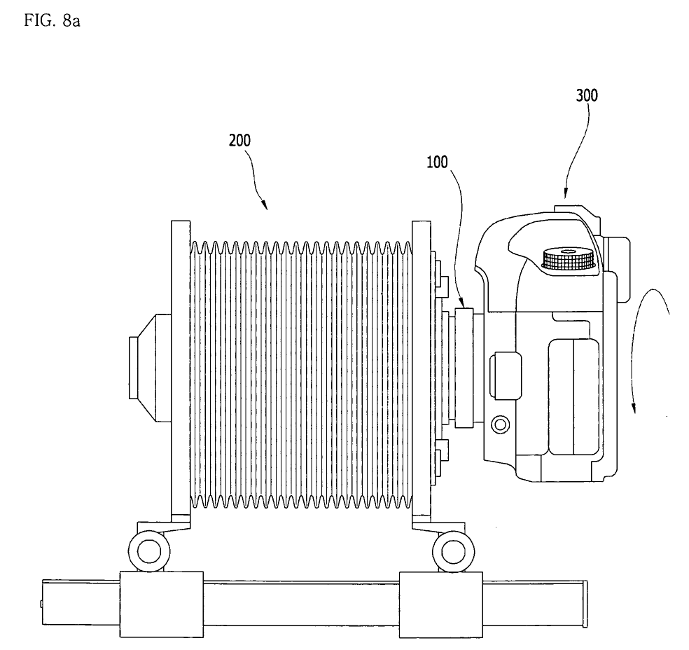

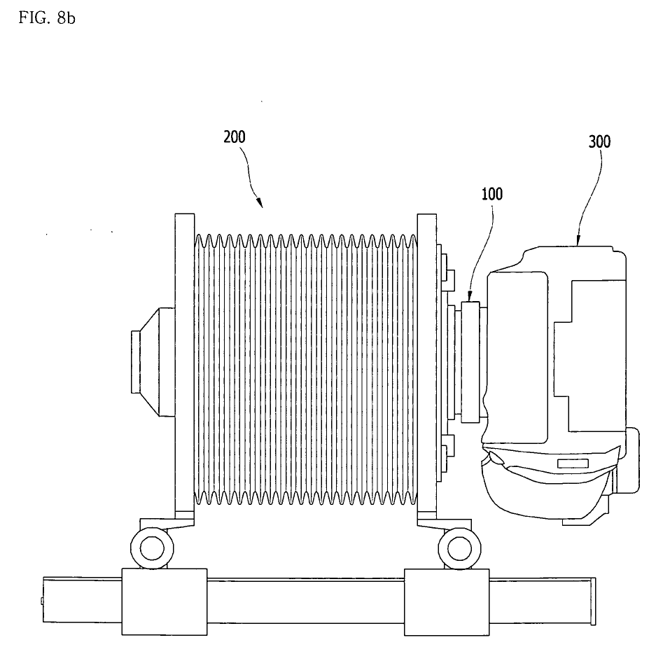

FIGS. 8a and 8b show a rotation of a digital single lens reflex camera by rotating a mount ring.

### DRAWINGS

### Reference Numerals

| | | | |
|---|---|---|---|
| 100 | connector panel for view camera | 110 | base panel |
| 120 | docking panel | 130 | protruding pieces |
| 140 | sliding panel | 150 | guiding strips |
| 160 | mount ring | 200 | view camera |
| 300 | digital single lens reflex camera | | |

### DETAILED DESCRIPTION

### FIGS. 1, 2, 5, 7

A complete embodiment of a connector panel 100 is illustrated in FIG. 2 (front view) and FIG. 5 (rear view). As shown in FIG. 1, the connector panel comprises a base panel 110, a docking panel 120, protruding pieces 130, a sliding panel 140, two guiding strips 150, and a mount ring 160.

The base panel has an overall dimension of 17.1 cm×11.9 cm, and its thickness is 0.5 cm. The size of the base panel is exactly same as the size of a film holder of a view camera, as the flat side of the base panel is to be placed on a rear standard of the view camera where a film holder is usually placed. The base panel has an opening 111 in the middle. A docking panel, which allows smooth movement for the sliding panel, is affixed to the base panel by bolts. The docking panel also has an opening 121 that conjoins with the opening of the base panel. After placing a sliding panel on top of the docking panel, the two guiding strips are affixed to the docking panel by bolts. As shown in FIG. 7, each guiding strip comprises a sliding pad 152. The sliding pad may have a thickness of approximately 1 mm and may be made up of silicon. The sliding pad minimizes the friction between the guiding strip and the sliding panel; thus the horizontal movement of the sliding panel is smooth.

There is a protruding piece on each side of the sliding panel; the protruding pieces can have various shapes. The front side of the sliding panel has the protruding piece to provide a small gap between an attached DSLR camera and the base panel thereby preventing any potential damages from collision. The mount ring is mounted to the front protruding piece. The rear side of the sliding panel has the protruding piece for the horizontal shifting of the sliding panel, as shown in FIGS. 4a to 4c. The protruding piece also has an opening 131 in the middle. All parts are made up of duralumin.

### OPERATION

### FIGS. 3, 4a-c, 6a-c, 8a-b

FIG. 2 shows an illustration of an ideal assembly of the connector panel, a view camera, and a DSLR camera. After one removes the lens of a DSLR camera, one docks the projecting side of the connector panel into the lens mount of the DSLR camera. For a Nikon mount, one rotates counter-clockwise. For a Canon mount, one rotates clockwise. To place the connector panel on a view camera, one removes the ground glass of a view camera and slides the connector panel onto a rear standard 220 of the view camera as if placing a film holder. Then to secure the attachment, one closes the lower lock and pulls down the upper lock on the back of the view camera. High performance lenses or any classic lenses can be attached to the front of the view camera to produce professional photography. Also, as indicated by arrows in FIG. 2, the view camera can perform various movements by moving a rail 231, a movement 230, and a front standard 210. And through the opening of the panel, images of view camera are saved to the image sensor of DSLR camera.

For panorama photo shoots, one slides the attached DSLR camera to the right and/or to the left. As shown in FIGS. 4b and 4c, pushing the DSLR camera applies force on the mount ring, which is attached to the protruding piece and the sliding panel. Thus, the sliding panel moves along with the DSLR camera. Eventually, the boundary of the opening of the base panel snubs the sliding panel from sliding further. The images then can be combined via Photoshop tools.

As shown in FIG. 5, edges of the opening in the base panel are semi-circular. The semi-circle shape maximizes the extent of which the sliding panel can be shifted. Hence, the area that the attached DSLR can photograph is maximized, without increasing the size of the base panel. However, the shape of the edges may not be limited to a semi-circle.

While the sliding panel shifts, it may be paused at designated places. FIGS. 6a to 6c show how temporary pauses can be made. The guiding strip may comprise at least one pausing groove 151, and the sliding panel may comprise a spring-like object 142 to support a tiny ball 141. When the ball is in contact with the guiding strip, the spring is compressed. As the sliding panel is shifted, the ball may roll over into the groove, allowing temporary pause at a designated place. Yet, applying greater force will continue the movement of the sliding panel. In other embodiments, the guiding strip may have the grooves, and the sliding panel may have the ball and the spring. Also, the method of temporary pauses may not be limited to the ball-and-spring method.

For vertical photographs, as shown in FIGS. 8a and 8b, one rotates the DSLR camera by rotating the mount ring of the connector panel. One can also take photographs at various angles by rotating the DSLR camera.

### ADVANTAGES

From the description above, a number of advantages of my connector panel become evident:
(a) Images of view camera can be easily saved as digital images through DSLR camera's image sensor. Hence, it becomes clearly easier to record, edit, and develop view camera's images.
(b) Advantages of large format cameras, such as movement and application of high performance lenses, are retained.
(c) A variety of combination can be made as any classic lens can be attached to the front of the view camera. Hence, one can personalize his or her camera equipment.
(d) No expenses are necessary for Polaroid tests.
   Multiple cuts of a subject may be taken by sliding the DSLR camera side-to-side, which then can be assembled together with Photoshop tools, producing panorama photographs with no distortions and no financial burden on the photographer.
(e) By rotating the DSLR camera, one can easily take vertical photographs for advertisement on tall buildings or waterfall photographs.

### CONCLUSION, RAMIFICATIONS, AND SCOPE

Accordingly, the reader will see that the connector panel brings together only the best of both analog photography and digital photography. All the advantages of using a view camera are retained; at the same time, technological advances of a digital camera replace the disadvantages of a view camera.

Furthermore, the connector panel has additional advantages in that:
It does not necessarily require new purchase of equipments. It revives what may have been neglected as a mere prop or stacked away. Also, it can recycle view cameras that are thrown away.

It gives a professional look for studio photographers, who need to sell their photographs to customers. As digital cameras are generalized to the public, in order to maintain their business, studio photographers need to present an impression that can distinguish them from amateur photographers. With a view camera in front, a customer, who may take family or wedding pictures, gets an elegant impression of the photographer. Yet, at the same time, the attached DSLR camera would provide all the digital conveniences for the customer.

Although the description above contains many specificities, these should not be construed as limiting the scope of the connector panel. Hence, the connector panel can be made of a different material, shape, and color. For example, the edges of the sliding panel can be rounded inward or outward; the protruding piece can have other shapes; the opening in the base panel or the sliding panel can also be made in a different shape.

Thus the scope of the embodiments should be determined by the appended claims and their legal equivalents, rather than by the example given.

I claim:

1. An article of a panel having means to attach a DSLR camera to a view camera, comprising:
(a) a base panel having an opening of various shape
(b) a sliding panel of various shape with an opening of various shape
(c) guiding strips having means to guide the horizontal shift of said sliding panel
(d) protruding pieces located front and back of said sliding panel
(e) a mount ring that is capable of rotating clockwise and counter-clockwise

2. The connector panel of claim 1 wherein said body of material is composed of duralumin.

3. The connector panel of claim 1 is colored.

4. The connector panel of claim 1 wherein said sliding panel and said guiding strips pause at designated places by various means.

5. A method of using the complete assembly of a connector panel, a DSLR camera, and a view camera, comprising:
(a) shifting said DSLR camera horizontally to take multiple shots of a subject for panorama photographs,
(b) rotating said DSLR camera to take photographs at different angles,
whereby said connector panel can easily connect a DSLR camera to a rear standard of a view camera, converting images of view camera to digital images and easily producing panorama photographs with no distortions.
